(19) United States
(12) Patent Application Publication
(10) Pub. No.: US 2012/0279410 A1
(43) Pub. Date: Nov. 8, 2012

(54) METHOD FOR DETERMINING SETTING ERRORS IN A SHEET-FED PRINTING PRESS

(75) Inventors: STEFAN BILLMAIER, WALLDORF (DE); WERNER HUBER, WIESLOCH (DE)

(73) Assignee: HEIDELBERGER DRUCKMASCHINEN AG, HEIDELBERG (DE)

(21) Appl. No.: 13/463,983

(22) Filed: May 4, 2012

(30) Foreign Application Priority Data
May 4, 2011 (DE) DE10 2011100413.4

(51) Int. Cl. B41L 39/14

(52) U.S. Cl. 101/484

(57) ABSTRACT

A method for determining setting errors in a sheet-fed printing press includes recording a geometry of a printed sheet running through the printing press with an imaging system and comparing the recorded geometry with intended geometries for evaluation. An imaging system oriented substantially perpendicular to a sheet surface at least partly registers visible contours of sheet edges and conclusions are drawn, from measured deviations of the sheet edges in relation to intended contours, as to at least one of the following setting errors of the printing press:
a faulty sheet transfer because of an incorrect setting of a gripper bar transporting the sheet,
a lifting of the sheet off an impression cylinder because of an incorrect setting of blown air for sheet guidance, or
an incorrect radius of the impression cylinder, for example because of incorrectly chosen underlays/cylinder covers.

### CROSS-REFERENCE TO RELATED APPLICATION

This application claims the priority, under 35 U.S.C.§119, of German Patent Application DE 10 2011 100 413.4, filed May 4, 2011; the prior application is herewith incorporated by reference in its entirety.

### BACKGROUND OF THE INVENTION

### Field of the Invention

The invention relates to a method for determining setting errors in a sheet-fed printing press, in which the geometry of the printed sheet running through is recorded by an imaging system and is compared with intended geometries for the purpose of evaluation.

It has already been known for some time to provide the printing units of sheet-fed printing presses with imaging systems such as video cameras or line sensors, for example, from which images of printed sheets running through thereunder are obtained in-line and evaluated for an extremely wide range of purposes. The main applications in that case are firstly the color control or control of the inking on the basis of spectral color differences detected in the subject in relation to the reference image, and secondly the detection of defects in the printed image, such as hickeys or scratches. In that second case, the imaging system is used for quality assurance in order to identify the sheets or parts thereof which are unsalable and may have to be separated out. In that case, too, the subject is compared with a fault-free reference.

German Patent Application DE 197 47 728 A1 discloses making deformations or relative movements of the printing material as it passes through the printing press visible in the form of schematic depictions. For that purpose, a number of measuring areas from differently colored partial measuring elements are disposed on printing plates exposed specifically for that purpose, and then the differently colored printed measuring areas are recorded by a video camera in relation to their position relative to one another and evaluated in order to draw conclusions therefrom about problems as the sheet passes through the printing press.

In that method, special printing plates are needed and paper has to be printed in order to detect the errors occurring during the sheet run by evaluating the printed sheets.

In German Patent Application DE 103 12 162 A1 and European Patent Application EP 1 155 854 A2, equipment for monitoring the sheet run is described, with which the sheet run is monitored physically by cameras, which view the sheet edge laterally and, as a result, are able to determine, for example, whether or not the printed sheet running through remains within predefined limiting positions at a distance from the cylinder surface and the sheet guiding equipment. That monitoring equipment is thus constructed specifically for the one purpose for which it is used, specifically to determine the physical position of the sheet, and cannot be employed to determine other setting errors, for example on the gripper bar. Furthermore, U.S. Pat. No. 7,478,806 discloses a sensor moved together with the sheet, which measures the position and inclination of the sheet in space and, in U.S. Pat. No. 7,481,429, signal processing electronics for sheet sensors are described.

### SUMMARY OF THE INVENTION

It is accordingly an object of the invention to provide a method for determining setting errors in a sheet-fed printing press, which overcomes the hereinafore-mentioned disadvantages of the heretofore-known methods of this general type and with which setting errors in the printing units of a sheet-fed printing press can be detected in a straightforward manner, using an imaging system oriented substantially perpendicular to the sheet surface.

With the foregoing and other objects in view there is provided, in accordance with the invention, a method for determining setting errors in a sheet-fed printing press. The method comprises recording a geometry of a printed sheet running through the printing press with an imaging system and comparing the recorded geometry with intended geometries for evaluation, orienting the imaging system substantially perpendicular to a sheet surface and at least partly registering visible contours of sheet edges, and drawing conclusions, from the measured deviations of the sheet edges in relation to intended contours, as to at least one of the following setting errors in printing units of the printing press:
faulty sheet transfer due to incorrect setting of grippers transporting the sheet,
excessive lifting of the sheet off an impression cylinder due to incorrect setting of blown air for sheet guidance, or
incorrect radius of the impression cylinder or of a blanket cylinder, for example because of incorrectly chosen underlays/cylinder covers.

Therefore, according to the invention, as opposed to the known methods, the visible contours of the sheet edges are at least partly registered by the imaging system aimed at the sheet surface, and the deviations of the sheet contours or contour sections in relation to the intended contours of the ideally rectangular sheet are measured. It is then possible to draw conclusions, from these measured deviations, at least as to one of the following setting errors of the machine:
1. a faulty sheet transfer because of incorrect setting of the gripper bar transporting the sheet,
2. the lifting of the sheet off the impression cylinder because of incorrect setting of the blown air for the sheet guidance, or
3. an incorrect radius of the impression cylinder above which the imaging system is fitted, for example because of incorrectly chosen cylinder covers/underlays.

The incorrect settings can be obtained without making use of printing plates specifically exposed with measuring marks for the measurement of the sheet run. Furthermore, in order to determine setting errors of the machine, it is possible to use a camera or a line sensor already contained in the printing press, which is primarily provided for other purposes, for example for the color control or the quality assurance of the sheet.

The method according to the invention can be carried out with relatively little effort, since it needs substantially only one camera, which is fixed to the respective printing units at points provided for that purpose and the signal therefrom is connected to the control system of the printing press. Through the use of an appropriate diagnostic program, the measured geometric deviations then permit the setting errors in the relevant printing unit to be identified. It is not necessary at all to print the sheet with an image or with patterns for this purpose, instead it is sufficient to arrange for white unprinted sheets to run through the machine, if appropriate at different speeds.

It is expedient, during the evaluation of the contours of the sheet edge, to use specifically selected sections of the sheet contour, in which the machine faults mentioned at the beginning are suppressed. Thus, it is possible to draw conclusions, from the distances of the contour sections of the leading sheet edge between the grippers to the gripper trailing edge, about incorrect gripper opening times or gripper bars located too high or too low. In a similar way, it is possible to draw conclusions, from the deviations of the contour sections of the leading sheet edge from a straight line, about incorrect settings between the sheet arrival time and the gripper closing times. Then, the rear part of the lateral sheet edges can be used for an evaluation, with conclusions being drawn from an apparent widening of the sheet, increasing from the time at which the sheet leaves the press nip, about the extent to which the printed sheet lifts off the impression cylinder. Furthermore, an incorrect cylinder diameter, for example brought about as a result of non-uniform, excessively thick or excessively thin underlays, manifests itself in a lateral offset of the contour of the side sheet edges, specifically at the time at which the trailing sheet edge leaves the press nip.

In order to improve the evaluation signals, it is expedient to subject them to digital edge filtering and, if appropriate, threshold value operations before the evaluation, in order to increase contrast.

Other features which are considered as characteristic for the invention are set forth in the appended claims.

Although the invention is illustrated and described herein as embodied in a method for determining setting errors in a sheet-fed printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a basic, fragmentary, diagrammatic, longitudinal-sectional view of a printing press having an imaging system for an in-line evaluation of printed sheets during a print job;

FIG. 2 is a plan view of an image of a sheet recorded by a camera following edge filtering and contrast improvement;

FIGS. 3 and 4 are enlarged, fragmentary, plan views showing a contour of a leading sheet edge under different machine conditions;

FIG. 5 is an enlarged, fragmentary, plan view showing a contour of a side sheet edge recorded in a region of a trailing sheet edge; and

FIG. 6 is an enlarged, fragmentary, plan view showing a contour of left and right side sheet edges recorded at a time at which the trailing sheet edge leaves a press nip.

### DETAILED DESCRIPTION OF THE INVENTION

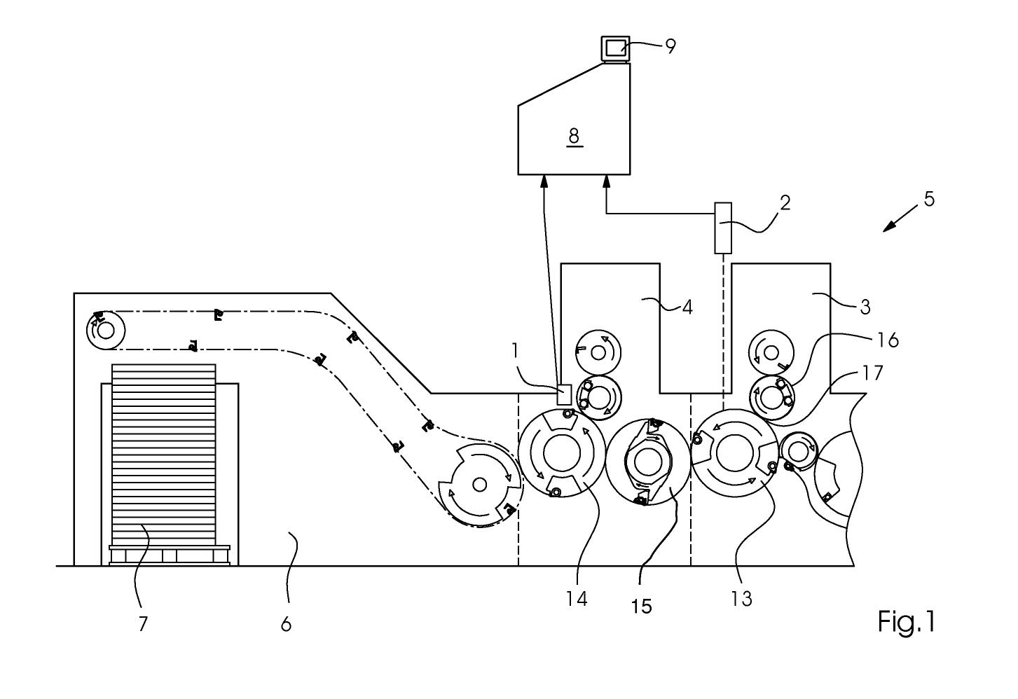

Referring now to the figures of the drawings in detail and first, particularly, to FIG. 1 thereof, there is seen a diagrammatically-depicted sheet-fed printing press 5 which has printing units 3 and 4, in which it is also possible for the printing unit 4 to be a varnishing unit. Of course, however, the printing press 5 has further printing units for the various colors to be printed, which are not shown in the figure for reasons of simplification. Sheets 7 printed by the printing press are deposited on a stack in a delivery 6 at the end of the printing press 5.

A camera 2, which is fitted to the printing unit 3, registers the sheet resting on an impression cylinder 13 of the printing unit 3 in the form of an image, as the sheet is conveyed from the impression cylinder 13, while held by grippers, in the direction of the next printing unit 4 and is picked up by a transferor or transfer cylinder 15 and transferred to an impression cylinder 14 of the printing unit or varnishing unit 4. The camera 2 is used for the inspection of the image printed onto the sheet and, at the cycle rate of the image changing frequency, in each case registers strip-like sections over the entire width of the sheet which are assembled, in the sheet running direction, to form an image of the entire sheet.

Incorporated in the printing unit 4 is a spectral line sensor 1, through which a spectral reflectance of the color-printed sheet is measured for the purpose of inking zone control. For this purpose, the line sensor 1 extends either over the entire sheet width or is composed of shorter individual lines, which are placed beside one another or can be moved to specific inking zones.

Both imaging systems, the camera 2 and the line sensor 1, are connected to a control system 8 of the printing press 5. There, their signals are subjected to various types of filtering and arithmetic operations by evaluation electronics, before the result is processed by a computer contained in the control system 8 into open-loop and closed-loop control signals for quality assurance, on one hand, and for the inking zone control, on the other hand, and is optionally displayed to the operator of the printing press on a monitor 9.

Through the use of each of the two imaging systems, the camera 2 and the line sensor 1, it is then also possible to detect the contours of the printed sheet running through under the camera 2 and the line sensor 1. In this case, only the signals from the pixels of the camera 2 or the line sensor 1 that are located at the edge of the image area are needed in order to image the lateral or side sheet edge. In order to image the leading and trailing edge, the signals supplied by the camera 2 and the line sensor 1 can be used when this edge is just running through the image area, which is achieved by suitable synchronization of the camera or sensor with a so-called machine angle, i.e. the angular position of the impression cylinders 13 and 14. This machine angle is known to the control system 8, which communicates with one or more encoders in the gear train of the printing press.

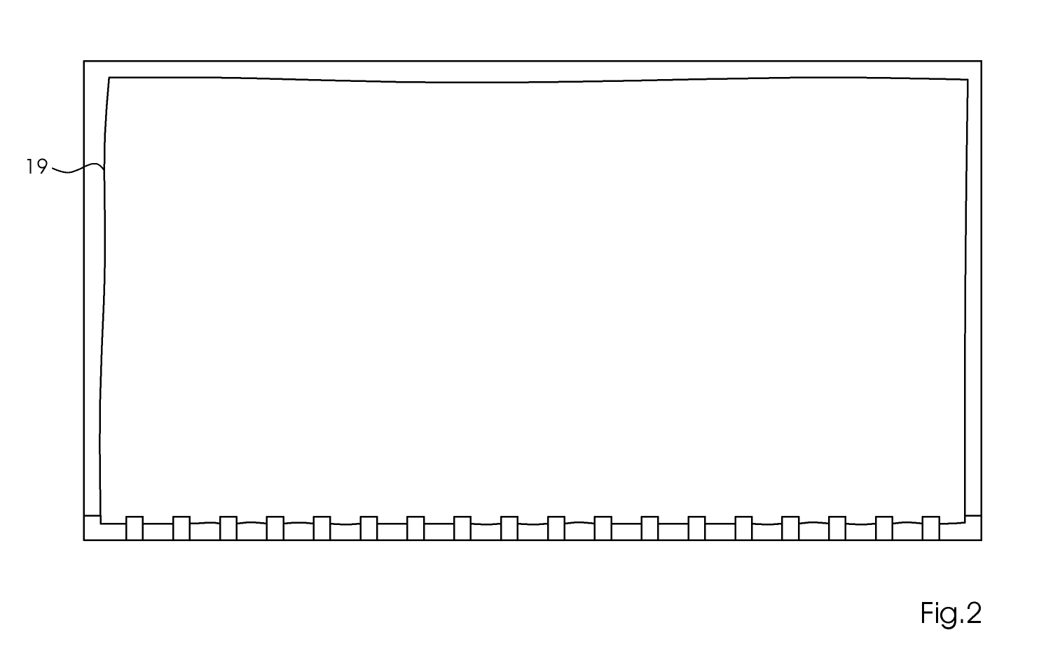

In FIG. 2 illustrates a typical contour 19 of the edges of a sheet running through the printing press 5, as seen either by the camera 2 or by the sensor 1. The sharp high-contrast outline is obtained because the image signals have firstly been subjected to edge filtering by a Sobel filter and secondly to a threshold value operation in order to increase the contrast. In the region of the leading sheet edge, it is possible to see the contours of eighteen grippers with which the sheet running through is held on the impression cylinder 13 or 14. The outline 19 illustrated in FIG. 2 exhibits some irregularities as compared with an ideal rectangle, which will be explained in more detail regarding in the following figures.

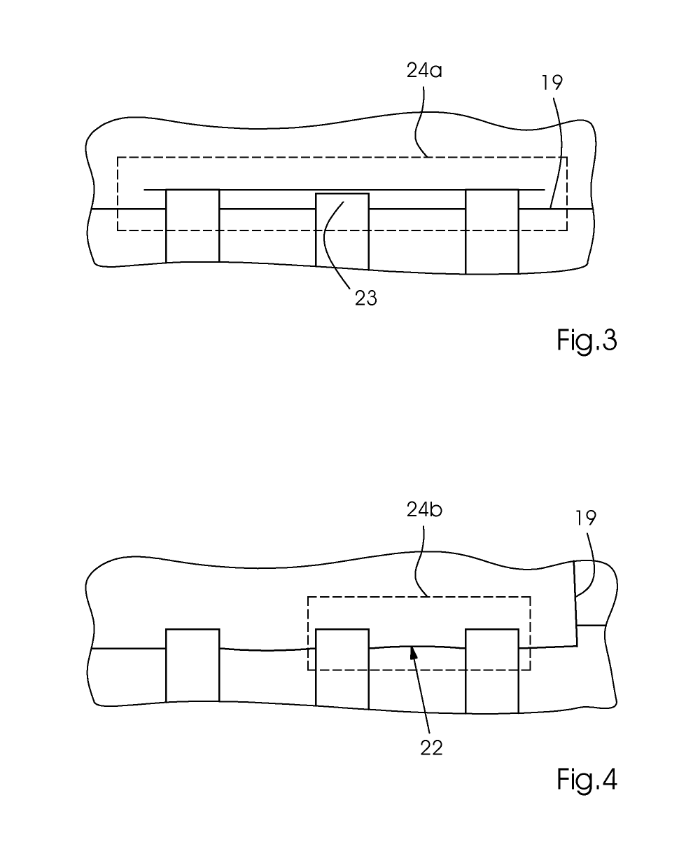

FIG. 3 shows a measuring area 24a on an enlarged portion of the leading sheet edge, illustrating that the contour of a central gripper 23 shown therein is displaced somewhat in the direction of the leading sheet edge. This shorter distance permits conclusions to be drawn about a gripper opening time differing in comparison with the grippers located alongside. Furthermore, different distances of the gripper contour in relation to the leading sheet edge could be attributed to the fact that the respective gripper pads on the impression cylinder, which hold the sheet, are located too high or too low as compared with the gripper bar on the transferring transferor 15.

FIG. 4 shows a measuring area 24b, from which it can be seen that the contour of the leading sheet edge is curved slightly in the region between the two grippers depicted on the right and a point designated by reference numeral 22, i.e. it deviates from a straight line. This is an indication that either the sheet is not resting smoothly on the impression cylinder, or an air cushion has formed under the sheet, which curves the sheet at this point. Another cause for this visualization is to be seen in the fact that the sheet arrival time and the gripper closing time do not match each other, i.e. that the sheet is still moving and is pushed forward by the transferring cylinder 15 before the relevant gripper closes.

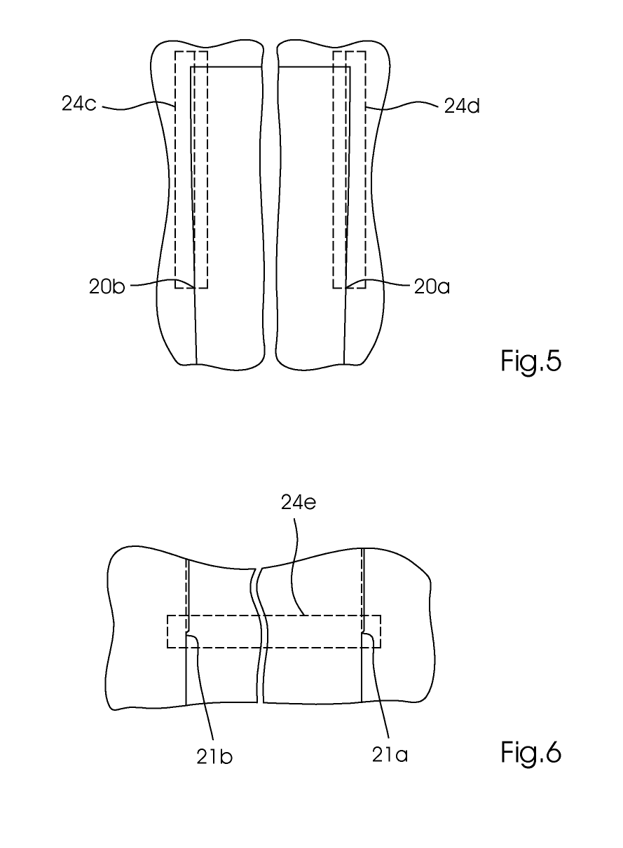

Measuring areas 24c and 24d of the right and left side edge of the sheet according to FIG. 5 illustrate that the image of the sheet contour shows a sheet that is apparently widened toward the trailing edge from a specific point. In actual fact, points which are respectively designated by references numerals 20a and 20b there, as a comparison with the machine angle shows, correspond to a time at which the sheet leaves a press nip 17 between the impression cylinder 13, for example, and a blanket cylinder 16 associated with the latter. Depending on the grammage of the sheet, this effect is differently highly pronounced and results from the fact that the sheet, after it is no longer tautened by the press nip, then lifts off the impression cylinder due to the rotational movement of the latter, with the extent of the lifting depending on the thickness/stiffness and the grammage, i.e. the paper weight. An excessively high apparent widening or, associated therewith, an excessively high lifting of the sheet off the impression cylinder is an indication of an incorrect setting of the blown air which is introduced after the press nip in order to assist the sheet guidance and by which the sheet is pressed onto the cylinder after leaving the press nip.

According to FIG. 6, in the case of a different incorrect setting of the machine, it is possible to see an apparent lateral offset of the sheet at points designated by reference numerals 21a and 21b in a measuring area 24e of the side edges of the sheet. In this case, too, this is again an apparent offset at the time at which the trailing sheet edge leaves the press nip 17. The cause of this is an incorrect underlay of the blanket on the blanket cylinder 16 or of a cylinder cover on the impression cylinder 13, due to which the ratio of the cylinder radii differs from the ratio of the angular speeds of the two cylinders from each other, with it also being possible for these deviations to vary over the cylinder length. In these cases, the sheet is subject to expansion and stretching as it passes through the press nip, i.e. considerable forces, which are relieved abruptly in milliseconds as it leaves the press nip and which move the sheet toward the side.

The effects described by using FIGS. 5 and 6 are usually superimposed, but the two can easily be separated from each other during the image evaluation.

The described effects of incorrect settings of the printing press on the image of the sheet contour depend on the printing unit, i.e. in each case they describe the incorrect settings of the printing unit with the sheet contour being depicted after the press nip of the printing unit. Since, on the other hand, these incorrect settings/maladjustments are relatively stable in the long term, it is sufficient to use the method according to the invention at relatively long intervals on the machine, for example at the service times which take place more or less regularly. A procedure in which the sheet contour is recorded by the imaging system, for example the camera 2, successively in the various printing units of the printing press is therefore particularly advantageous. To this end, mountings can be installed on the individual printing units, in which the camera 2 is fixed in such a way that it can easily be changed, so that it is used successively in the individual printing units while an unprinted stack of paper is conveyed through the machine. The same is also true to this extent for the case in which a line sensor 1 is used instead of the camera 2.

It is entirely possible for a plurality of images of various printed sheets to be recorded one after another by the camera 2 or the line sensor 1, in order to either improve the signal/noise ratio of the edge image and therefore to increase the measurement accuracy or in order to establish whether or not the measured deviations involve a reproducible error.

1. A method for determining setting errors in a sheet-fed printing press, the method comprising the following steps:
recording a geometry of a printed sheet running through the printing press with an imaging system and comparing the recorded geometry with intended geometries for evaluation;
orienting the imaging system substantially perpendicular to a sheet surface and at least partly registering visible contours of sheet edges; and
drawing conclusions, from the measured deviations of the sheet edges in relation to intended contours, as to at least one of the following setting errors in printing units of the printing press:
faulty sheet transfer due to incorrect setting of grippers transporting the sheet,
excessive lifting of the sheet off an impression cylinder due to incorrect setting of blown air for sheet guidance, or
incorrect radius of the impression cylinder or of a blanket cylinder.

2. The method according to claim 1, wherein the incorrect radius of the impression cylinder or of the blanket cylinder is due to incorrectly chosen underlays or cylinder covers.

3. The method according to claim 1, which further comprises drawing conclusions about incorrect gripper opening times or gripper pads being located too high or too low from distances of contour sections of a leading sheet edge between grippers to a trailing gripper edge.

4. The method according to claim 1, which further comprises drawing conclusions about incorrect settings between a sheet arrival time and gripper closing times from deviations of contour sections of a leading sheet edge from a straight line.

5. The method according to claim 1, which further comprises drawing conclusions about an extent to which a printed sheet lifts off the impression cylinder from an apparent widening of the sheet, increasing from a time at which the sheet leaves a press nip.

6. The method according to claim 1, which further comprises drawing conclusions about an incorrectly chosen underlay or an incorrectly chosen cylinder cover from a horizontal contour offset at a time at which a trailing sheet edge leaves a press nip.

7. The method according to claim 1, wherein the imaging system is a video camera or a line sensor.

8. The method according to claim 1, which further comprises evaluating signals supplied by the imaging system for a plurality of sheets running through the printing press one after another in order to determine the setting errors of the printing press.

9. The method according to claim 1, which further comprises placing a plurality of imaging systems in respectively different printing units of the printing press.

10. The method according to claim 1, which further comprises successively fixing the imaging system to different printing units.

11. The method according to claim 1, which further comprises conveying unprinted sheets through the printing press and depositing the unprinted sheets on a delivery stack, in order to image sheet contours.

12. The method according to claim 1, which further comprises using previously selected sheet contour sections for an evaluation of geometric deviations.

13. The method according to claim 1, which further comprises subjecting image signals describing a sheet contour or contour sections to digital edge filtering before their evaluation.
